(19) United States
(12) Patent Application Publication
(10) Pub. No.: US 2022/0196421 A1
(43) Pub. Date: Jun. 23, 2022

(54) NAVIGATION SYSTEM FOR BATTERY ELECTRIC VEHICLE

(71) Applicant: DENSO CORPORATION, Kariya-city (JP)

(72) Inventors: Yoshinori KAWABATA, Kariya-city (JP); Chihiro HIRANO, Kariya-city (JP); Toshihiro SHINTAI, Kariya-city (JP); Masahiko KAWAMOTO, Kariya-city (JP); Takaaki SUGIYAMA, Kariya-city (JP)

(21) Appl. No.: 17/694,833

(22) Filed: Mar. 15, 2022

Related U.S. Application Data
(63) Continuation of application No. PCT/JP2020/033067, filed on Sep. 1, 2020.

(30) Foreign Application Priority Data
Sep. 20, 2019 (JP) 2019-171994

(51) Int. Cl. G01C 21/34; G07C 5/02; G07C 5/00; G07C 5/08

(52) U.S. Cl. CPC G01C 21/3469; G07C 5/02; G07C 5/004; B60L 50/60; G07C 5/008; G01C 21/3476; G07C 5/085

(57) ABSTRACT

A navigation system provides advice to a driver of a battery electric vehicle regarding charging a battery mounted in the battery electric vehicle. The navigation system includes an input device, a storage medium, a measurement device, and a controller. The input device is configured to receive an input of a normal state during driving in advance by the driver. The normal state during driving is recognized by the driver. The storage medium is configured to store the normal state received by the input device. The measurement device is configured to measure a current state during driving. The controller is configured to calculate a difference between the normal state stored and the current state measured, and set the advice according to the difference to provide the driver.

### CROSS REFERENCE TO RELATED APPLICATIONS

The present application is a continuation application of International Patent Application No. PCT/JP2020/033067 filed on Sep. 1, 2020, which designated the U.S. and claims the benefit of priority from Japanese Patent Application No. 2019-171994 filed on Sep. 20, 2019. The entire disclosures of all of the above applications are incorporated herein by reference.

### TECHNICAL FIELD

The present disclosure relates to a navigation system for a battery electric vehicle.

### BACKGROUND

There is known a navigation system for battery electric vehicles. In such a navigation system, a shortest path search unit uses a departure point, destination, current battery level, and battery capacity, and if necessary, the availability information on the charging station or traffic information. To prevent the battery from running out when searching for a route to move from the departure point to the destination, the short path search unit searches for the route that has the shortest travel time, including the charging time, among the routes that pass through n or more charging stations.

Further, at the checkpoint in the middle of the route, the display terminal displays the comparison between (i) the estimated battery level calculated at the time of route search and (ii) the actual battery level when the checkpoint is actually passed. As a result, the user can know whether or not the vehicle is running smoothly.

### SUMMARY

According to an example of the present disclosure, a navigation system is configured to provide advice to a driver of a battery electric vehicle regarding charging a battery mounted in the battery electric vehicle. The navigation system includes an input device, a storage medium, a measurement device, and a controller. The input device is configured to receive an input of a normal state during driving in advance by the driver. The normal state during driving is recognized by the driver. The storage medium is configured to store the normal state received by the input device. The measurement device is configured to measure a current state during driving. The controller is configured to calculate a difference between the normal state stored and the current state measured, and set the advice according to the difference to provide the driver.

### BRIEF DESCRIPTION OF DRAWINGS

The objects, features, and advantages of the present disclosure will become more apparent from the following detailed description made with reference to the accompanying drawings. In the drawings:

FIG. 1 is an explanatory diagram showing an overall configuration of a navigation system for a battery electric vehicle;

FIG. 2 is a diagram showing purposes and examples of advice set according to the points of state difference;

FIG. 3 is a diagram showing examples of factors that deviate from the normal state of the driver, their parameters, the normal state recognized by the driver, the current state, and points (quantified state differences);

FIG. 4 is a diagram showing an example in which advice content is set according to the driving experience of the driver;

FIG. 5 is a flowchart for setting a normal state of a driver; and

FIG. 6 is a flowchart showing a control for providing advice to the driver.

### DETAILED DESCRIPTION

The following will describe embodiments for carrying out the present disclosure with reference to the drawings. In each embodiment, portions corresponding to the elements described in the preceding embodiments are denoted by the same reference numerals, and redundant explanation may be omitted. When only a part of a configuration is described in an embodiment, another preceding embodiment may be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

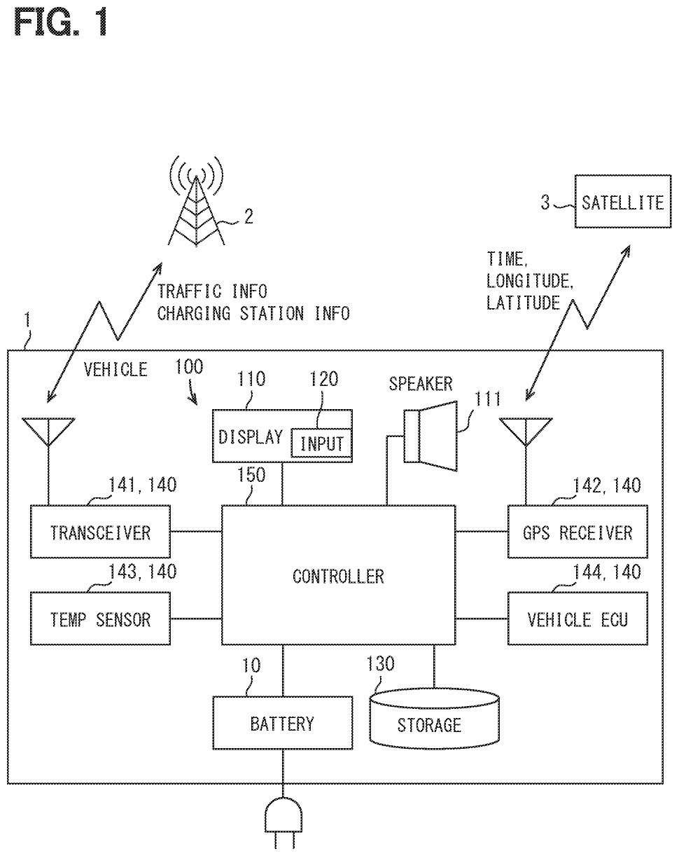

A navigation system 100 for a battery electric vehicle (hereinafter referred to as a navigation system 100) according to a first embodiment will be described with reference to FIGS. 1 to 6. The navigation system 100 is used for a battery electric vehicle the driving source of which is an electric motor driven by a battery 10. Hereinafter, the battery electric vehicle will be referred to as a vehicle 1. The navigation system 100 is a system that mainly displays the current position on a map, guides the driver to the destination, and provides the driver with advice on charging the battery 10. As shown in FIG. 1, the navigation system 100 includes a display device 110, an input device 120, a storage medium 130, a measurement device 140, and a charging advice controller 150.

The display device 110 is configured to display the current position information on the map, destination guidance information, and advice information on charging, to the driver. The display device 110 uses a liquid crystal display, an organic EL display, or the like. The display device 110 is arranged at a position that is easy for the driver to see, for example, at the center position of the upper part of the instrument panel.

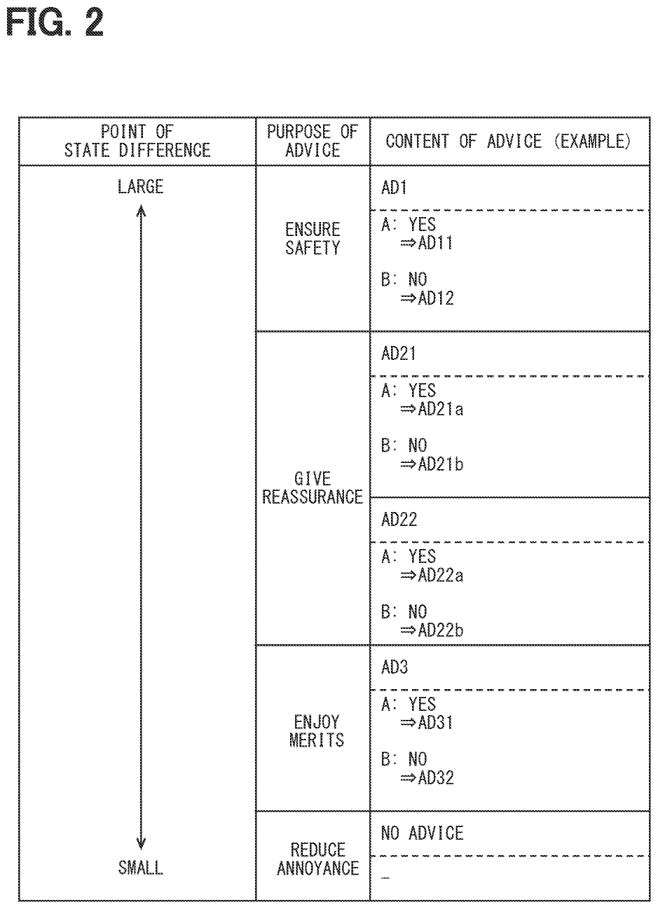

The advice information displayed by the display device 110 includes, regarding charging of the battery 10, the advice for ensuring safety, the advice for giving reassurance, and the advice for enjoying merits, as shown in FIG. 2. The details will be described later. The advice information is displayed on the screen of the display device 110, for example, in characters so that the driver can see it. In addition, the advice information can also be obtained by speech from an attached speaker 111.

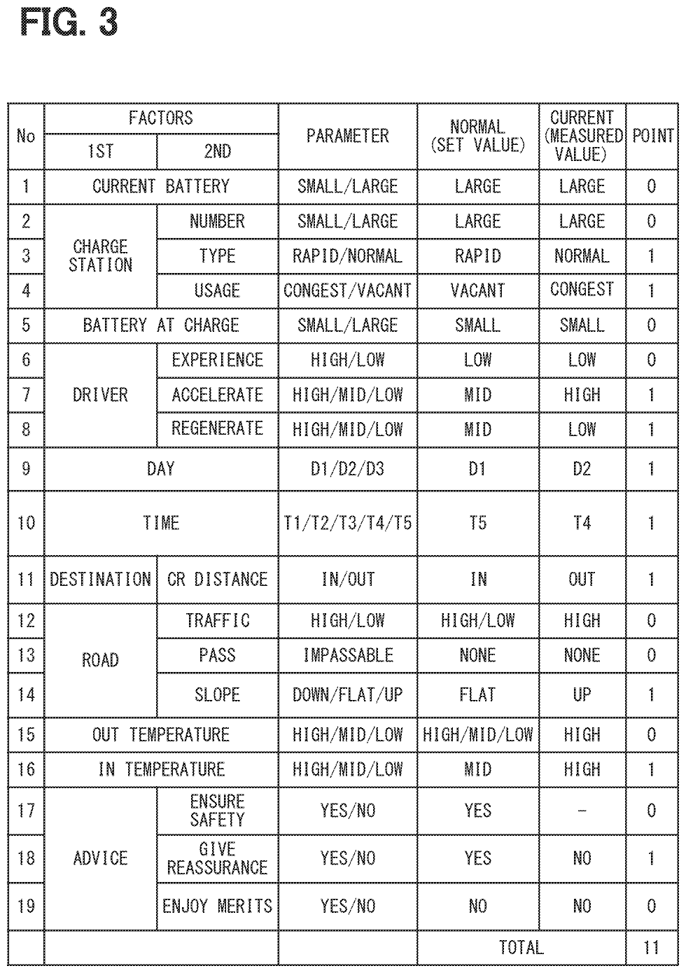

The input device 120 is used for the driver himself/herself to input a destination for searching for a guidance route, for instance. In the present embodiment, the input device 120 is further used for the driver himself/herself to input in advance the items in the normal state during driving (FIG. 3, which will be described in detail later) that the driver himself/herself recognizes. When the vehicle 1 is used by one driver, the items in the normal state of the driver are input from the input device 120. In addition, there may be a plurality of different drivers. For example, the vehicle 1 may be used by a family. When the vehicle 1 is a rental car, the vehicle 1 may be used by an unspecified number of people. In such cases, the items in the normal state for each different driver are input from the input device 120.

The input device 120 is formed as, for example, a touch panel input device provided in the entire area or a part of the display screen of the display device 110. The touch panel input device enables selection input (touch input), character input, and the like for the items transparently displayed in the display device 110, by a touch operation with the driver's finger.

The input device 120 is not limited to the touch panel input device formed on the display screen of the display device 110. In addition, the input device 120 may be a touch pad, a joystick, a mechanical switch, and a speech input, which are provided at a position away from the display device 110, for example, a position that is easily accessible by the driver (a position close to the driver) such as a center console.

The storage medium 130 stores item data in a normal state of an individual driver or a plurality of different drivers input from the input device 120, and map data containing road data and facility data including position data of charging stations. The storage medium 130 may also be referred to as a storage device or a storage. For instance, in FIG. 1, the storage medium 130 is provided in the vehicle 1, and the navigation system 100 may be mounted in the vehicle 1. However, there is no need to be limited thereto. Alternatively, for example, if the vehicle 1 is a rental car, the storage medium 130 may be provided at a base station 2 that wirelessly communicates with the vehicle 1; namely, the navigation system 100 may include the base station 2 including the storage medium 130. Further, the storage medium 130 may be provided in each of the vehicle 1 and the base station 2. When the storage medium 130 is provided in the vehicle 1, the storage medium 130 is connected to the charging advice controller 150, which will be described later. The item data in the normal state and the map data are output to the charging advice controller 150.

The measurement device 140 is a part that measures the current state of the driver during driving as shown in FIG. 3. Details will be described later. The measurement device 140 includes a battery 10, a transceiver 141, a GPS receiver 142, a temperature sensor 143, and a vehicle ECU 144 (which detects various vehicle information), which are in-vehicle devices mounted in the vehicle 1. Such in-vehicle devices are connected to the charging advice controller 150 to output a variety of data including measurement information or detection information to the charging advice controller 150. This enables the charging advice controller 150 to obtain measured values for respective evaluation items, which will be described later in detail. Note that the charging advice controller 150 may be functioning as part of the measurement device 140. In other words, the charging advice controller 150 along with an in-vehicle device including each of the battery 10, the transceiver 141, the GPS receiver 142, the temperature sensor 143, and the vehicle ECU 144 may also be referred to as a vehicle state detector to detect or obtain measurement information or a measured value for a corresponding evaluation item.

The battery 10 outputs the current remaining battery level based on the remaining amount detection to the charging advice controller 150. The charging advice controller 150 calculates the cruising range from the remaining battery level.

The transceiver 141 transmits and receives to and from the external base station 2. Mainly, the transceiver 141 receives the charging station information and the traffic information managed by the base station 2. The received traffic information and charging station information are output to the charging advice controller 150. The traffic information includes, for example, information such as traffic volume (congestion status) and passable/impassable (whether or not traffic is closed). Further, the charging station information includes, for example, information such as the position, number, type (quick charging type or normal type) of charging stations, and usage status (congested or vacant).

Note that suppose a case where the base station 2 is provided with a storage medium for storing the driver's normal state data and map data. In this case, the transceiver 141 can receive the stored normal state data of the driver and the map data from the base station 2 and output them to the charging advice controller 150.

For instance, the present embodiment employs the GPS receiver 142 as one of global navigation satellite system receiver each configured to receive electric wave signals from navigation positioning satellites to obtains data such as the current time, the position (latitude, longitude) of the vehicle 1 and the slope of the traveling road from the satellite 3 in the GPS (Global Positioning System), and outputs the data to the charging advice controller 150. The GPS receiver 142 may be basically functioning as a current position detector.

The temperature sensor 143 is a temperature detecting means, for example, detects the temperature outside the vehicle 1 and inside the vehicle 1 (outside air temperature, inside air temperature), and outputs the detected temperature data to the charging advice controller 150.

The vehicle ECU 144 is a controller that controls the operation of various in-vehicle devices mounted on the vehicle 1, and outputs, for example, the accelerator opening degree, the amount of regeneration when charging the battery 10, and the like to the charging advice controller 150.

The charging advice controller 150 first obtains a difference (which also be referred to as a state difference) between (i) the normal state during driving, which is stored in the storage medium 130 (in the vehicle 1 and/or the base station 2) and recognized by the driver himself/herself, and (ii) the current state of the driver during driving measured by the measurement device 140. The charging advice controller 150 then sets and provides advice to the driver according to the state difference. Details will be described later.

Further, the charging advice controller 150 includes an identification unit that identifies an actual driver who actually drives from a plurality of different drivers. For example, in the case where the smart entry system is installed in the vehicle 1, the identification unit identifies the actual driver (Mr. A, Mr. B, Mr. C . . . ) from the authentication ID in the smart key owned (carried) by one of the different drivers. Alternatively, a smartphone, which is carried by one of the different drives and stores each driver's authentication data, may be used, instead of a smart key. That is, the identification unit may identify the actual driver using the identification data obtained by wirelessly communication with the smartphone.

The configuration of the navigation system 100 according to the present embodiment is as described above, and the operation effects will be described below with reference to FIGS. 2 to 6.

FIG. 2 is a diagram of a list showing the advice (the purpose of the advice and the content of the advice) provided by the charging advice controller 150 to the driver for the points quantifying the state difference (difference between the normal state of the driver and the current state).

The purpose of the advice is to “ensure safety”, “give reassurance”, “enjoy merits”, and “reduce annoyance” for the driver in descending order of the state difference (i.e., points). In addition, the content of the advice is a proposal type that allows the driver to select the advice. In response to the driver's response (Yes or No), the advice explains a possible future event and encourages the next action. In addition, the content of the advice is to notify the driver of a possible future event when the driver does not follow the advice (No).

The advice for ensuring safety is provided when the state difference is relatively large. When the state difference is relatively large, the degree of deviation from the normal state is large, and the driver often cannot predict the situation, so that the vehicle is prepared for an emergency. As the content of the advice for ensuring safety, for example, the advice AD1 indicates whether or not the vehicle 1 is headed for the charging station when the charge amount of the battery 10 is small. If the driver makes a positive choice, the advice AD11 is provided which instructs the driver to search for a charging station with the highest priority. If the driver makes a negative choice and the battery runs out, the advice AD12 is provide which instructs the driver to stop the vehicle 1 in a safe place without rushing and to call the road service.

In addition, the advice for giving reassurance is to eliminate the anxiety state before the driver falls into an emergency. Even if the driver does not act according to the advice, the anxiety is resolved by encouraging the next action. As the content of the advice for giving reassurance, the advice AD 21 is provided which indicates whether or not to go to the charging station under the state where although the amount of charge is decreasing, the vehicle 1 is possible to reach the destination with the current amount of charge of the battery 10. If the driver makes a positive choice, the advice AD21a is provided which instructs the driver to search for a charging station, before arriving at the destination. If the driver makes a negative choice, the advice AD21b is provided which recommends the driver to check the amount of charge when moving to the next destination after arriving at the current destination.

In addition, as the content of the advice for giving reassurance, the advice AD22 is provided which indicates whether or not to search for a charging station around the destination in advance. If the driver makes a positive choice, the advice AD22a is provided which instructs the driver to search for a charging station around the destination. If the driver makes a negative choice, the advice AD22b is provided which recommends the driver to check the amount of charge and stop at a nearby charging station before leaving for the next destination.

In addition, the advice for enjoying merits can be selected in various ways because the driver can afford it. As the content of the advice for enjoying merit, the advice AD3 is provided which indicates whether or not to charge in advance and search for a nearby charging station. If the driver makes a positive choice, the advice AD31 is provided which instructs the driver to search for a nearby free charging station. If the driver makes a negative choice, the advice AD32 is provided to notify the driver that charging during breaks will make effective use of time, and the cruising range can be extended by setting the air conditioner and driving mode to “economy”.

When the state difference is relatively small, it is determined that the vehicle is in a normal state and there is no problem in the behavior as the driver intends. In order to reduce annoyance to the driver, no particular advice is thus given.

Next, FIG. 3 is a diagram of a list showing examples of factors that deviate from the normal state of the driver (scenes that deviate from the normal state), their parameters, the normal state of the driver (set value), the current state (measured value), and points (quantified state difference). Note that the factor may also be referred to as an evaluation item.

As shown in No. 1 to No. 19 in FIG. 3, the factors that deviate from the normal state of the driver are based on the status of the charging station, the road status, the driving environment, etc., in addition to the vehicle usage status of the driver. Specifically, the factors that deviate from the driver's normal state include the current battery level, charging station information (number, type, usage status), battery level at the start of charging, and driver information (driving experience, the accelerator opening degree, the amount of regeneration to the battery 10 at the time of charging). In addition, the factors that deviate from the normal state of the driver further include the day and time of driving. In addition, the factors that deviate from the normal state of the driver include whether the home or destination is within the cruising range. In addition, the factors that deviate from the normal state of the driver include the road status (traffic volume, passable/impassable, gradient), the outside air temperature, the inside air temperature, the response to advice (ensuring safety, giving reassurance, enjoying merits).

The parameters are those in which a plurality of states are set in advance for the factors that deviate from the normal state. The parameters are set for each of the factors that deviate from the normal state as follows. Whether the current battery level is small or large. Whether the number of charging stations is small or large. Whether the battery level at the start of charging is small or large. Furthermore, whether the driving experience of the driver is deep or shallow (i.e., high or low). Whether the accelerator opening is large, middle, or small (i.e., high, middle, or low). Whether the amount of regeneration to the battery 10 during charging is high, middle, or low. Whether the driving day is (i) weekday, (ii) weekend, or (iii) public holiday (D1, D2, D3 in FIG. 3). Whether the driving time zone is (i) early morning, (ii) morning, (iii) afternoon, (iv) midnight, or (v) commuting time (T1, T2, T3, T4, T5 in FIG. 3). Whether the cruising distance is within or outside the range. Furthermore, whether the traffic volume is congested or vacant. Whether the road ahead is passable or impassable (closed). Whether the slope of the road is down, flat, or up. Whether the outside temperature is high, middle, or low. Whether the inside temperature is high, middle, or low. Whether the response to the advice is Yes or NO.

The normal state of the driver is a set value set by inputting a state recognized as normal by the driver for each evaluation item from the input device 120. For example, in No. 1 of FIG. 3, the state where the “current remaining battery level” is “large” is the normal state recognized by the driver himself/herself. The same applies to other evaluation items. As shown in No. 12 and No. 15 of FIG. 3, the driver is enabled to input a plurality of set values as a normal state of the driver, for example.

The current state is a measured value indicating the current state of the driver measured by each measurement device 140. For example, in No. 1 of FIG. 3, the current remaining battery level is large (i.e., high). In No. 2 of FIG. 3, the number of charging stations is large. The same applies to other evaluation items.

The point is a numerical value (quantified value) of the state difference (difference between the driver's normal state and the current state). For example, the larger the state difference, the larger the point is set, which indicates that the degree of deviation from the normal state of the driver increases. FIG. 3 shows a case where when there is a state difference, the point is set to 1, and when there is no state difference, the point is set to 0, and the total points (i.e., total score) is 11 points.

The magnitude of the point is not limited to 0 or 1 as shown in FIG. 3. Weighting may be adopted according to the state difference, such as points 2, 3, 4, and the like.

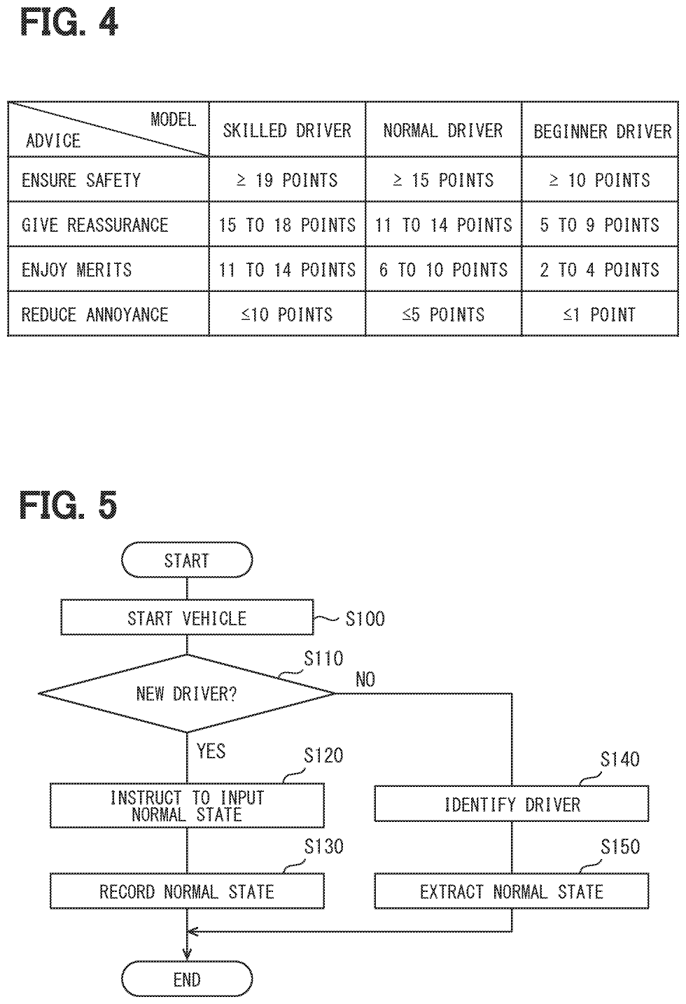

Next, FIG. 4 is a diagram of a list showing an example of setting the advice content according to the driving experience of the driver. Here, for example, the driving experience is divided into three stages: a skilled driver, a normal driver, and a beginner (inexperienced driver). Then, the charging advice controller 150 sets each advice (ensuring safety, giving reassurance, enjoying merits, reducing annoyance) for each level of driving experience according to the points based on the state difference. That is, to provide each advice, the higher points are needed for the skilled driver, normal, and beginner are applied in this order. That is, even if the points are relatively low, the charging advice controller 150 provides the beginner with any one of four types of the advice. In contrast, the experienced drivers is not provided with any types of the advice, unless the points are equal to or higher than certain level.

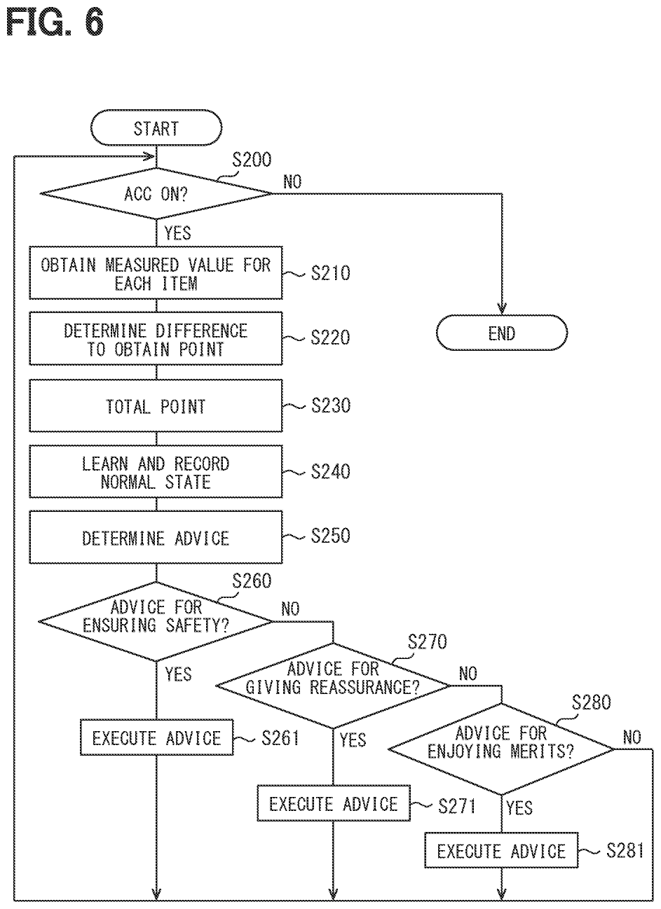

Next, the control procedure executed by the charging advice controller 150 will be described with reference to the flowcharts of FIGS. 5 and 6.

First, the charging advice controller 150 uses the flowchart shown in FIG. 5 based on the recording (stored) history of the driver's normal state (set value data). For a new driver for the first time, the data in the normal state recognized by the new driver is newly recorded; for the driver for the second time or more frequent times, the data in the normal state already stored is extracted. This flowchart is executed for each driving (every time the vehicle 1 is started). The identification of the actual driver is made by the identification unit described above.

Specifically, in step S100, the ignition switch (or start switch) of the vehicle 1 is turned on to start the vehicle 1. Then, in step S110, the charging advice controller 150 determines whether or not the actual driver is a new driver from the driver's authentication ID, authentication data, and the like. That is, the charging advice controller 150 determines that the actual driver is a new driver when the data in the normal state of the driver is not stored in the storage medium 130. When the data of the normal state of the driver is already stored, the charging advice controller 150 determines that the actual driver is not a new driver (the driver for the second time or more frequent times).

Next, in step S120, the charging advice controller 150 sends a message to the driver such as “Please input data in the normal state” from the display device 110 (or from the speaker 111), for example. Based on this, the driver is instructed to input the data of the driver's normal state described with reference to FIG. 3 as a set value for each evaluation item, via the input device 120.

Then, in step S130, the charging advice controller 150 records (stores) the data in the normal state of the driver on the storage medium 130.

On the other hand, in step S110, when the charging advice controller 150 determines that the actual driver is not a new driver, the charging advice controller 150 identifies the driver in step S140. In step S150, the driver's normal state data already recorded is extracted from the storage medium 130.

According to the above, the preparation of the data in the normal state of the actual driver at the start of operation is completed.

Next, the charging advice controller 150 grasps the state difference (difference between the normal state and the current state) in the actual driver by using the flowchart shown in FIG. 6, and provides advice to the actual driver according to the state difference. The flowchart of FIG. 6 is repeated every predetermined time (for example, 3 to 10 minutes).

Specifically, in step S200, the charging advice controller 150 determines whether or not the ignition switch (or start switch) of the vehicle 1 is turned on. When it is determined that the ignition switch is turned on, the process proceeds to step S210.

In step S210, the charging advice controller 150 obtains the current state (measured value) with respect to the evaluation item of the normal state of the driver from the measurement device 140 (battery 10, transceiver 141, GPS receiver 142, temperature sensor 143, and vehicle ECU 144).

Next, in step S220, the charging advice controller 150 determines the difference (state difference), with respect to each of a plurality of evaluation items, between the data in the normal state and the current state measured by the corresponding measurement device 140 and converts the difference into points. For example, in No. 1 of the list in FIG. 3, if the normal state is “large” and the current state is “large” with respect to the current remaining battery level, there is no state difference and it is determined to be point 0. Alternatively, in No. 3 of the list in FIG. 3, regarding the type of charging station, if the normal state is “rapid” and the current state is “normal”, it is determined that there is a state difference and it is determined to be point 1.

Next, in step S230, the charging advice controller 150 sums all the points of the plurality of evaluation items.

Next, in step S240, the charging advice controller 150 learns the normal state of the driver and stores it in the storage medium 130. Suppose a case where the charging advice controller 150 obtains a plurality of measured values as the current state for a plurality of cycles, and finds a change from a first measured value for a first cycle to a second measured value for a second cycle following the first cycle, and such a second measured value is continuously obtained for a predetermined number of cycles following the second cycle. In such a case, the second measured value is regarded as the normal state of the driver, and the data in the normal state of the storage medium 130 is updated (learning update).

Next, in step S250, the charging advice controller 150 applies the total points calculated in step S230 to the list in FIG. 4 to determine advice to the driver. For example, as shown in FIG. 3, when the total score is 11 points, and the driver's driving experience is at a normal level, advice for giving reassurance is determined.

Next, the charging advice controller 150 determines in step S260 whether or not the determined advice is advice for ensuring safety. When the affirmative determination is made, the advice for ensuring safety is provided in step S261.

Further, when a negative determination is made in step S260, the charging advice controller 150 determines whether or not the advice determined is advice for giving reassurance in step S270. When an affirmative determination is made in step S270, the advice for giving reassurance is provided in step S271.

Further, when a negative determination is made in step S270, the charging advice controller 150 determines whether or not the advice determined in step S280 is advice for enjoying merits. When an affirmative determination is made, the advice for enjoying merits is provided in step S281.

In step S261, step S271, and step S281, the charging advice controller 150 displays the content of the advice on the display device 110 and outputs the speech from the speaker 111 to notify the driver of the content of the advice.

Then, after step S261, step S271, and step S281, and the negative determination in step S280, the charging advice controller 150 returns to step S200. Until it is determined in step S200 that the ignition switch is turned off (when one driving is completed), the processing from step S200 is repeated.

As described above, in the present embodiment, the charging advice controller 150 calculates the state difference between the driver's normal state data stored in the storage medium 130 and the driver's current state measured by the measurement device 140. According to the calculated state difference, the charging advice controller 150 sets the advice to be provided to the driver.

As a result, advice is provided according to the state difference between the normal state and the current state of the driver during driving. Therefore, as the state difference is larger, the situation for the driver is more unexpected; thus, the driver can obtain advice suitable for the situation, and safe and secure driving becomes possible. When the state difference is relatively small, the driver is in a clear situation and the provision of advice is suppressed (no advice). Therefore, the driver may not feel annoyed by the advice provided one by one.

Further, the normal state of the driver is a set value set by the driver with respect to an evaluation item, and the current state of the driver is a measured value measured by the measurement device 140 with respect to the evaluation item. As a result, the normal state of the driver can be clarified, and the current state can be surely grasped, so that the state difference can be clearly determined.

In addition, the advice is set as advice for ensuring safety to the driver, advice for giving reassurance to the driver, and advice for the driver to enjoy merits in descending order of the state difference. As a result, the driver can perform driving in ensuring safety, driving in giving reassurance, or driving in enjoying merits, depending on the state difference.

Further, the charging advice controller 150 notifies the driver of a possible event when the driver does not follow the advice. As a result, the driver can be urged to prepare for the next action, and the driver's anxiety can be eliminated.

Further, the normal state of the driver is stored in the storage medium 130 for each of a plurality of different drivers. As a result, even when different drivers drive the vehicle 1 (even when the driver changes), it is possible to give advice based on the normal state of each driver.

Further, the charging advice controller 150 includes an identification unit that identifies an actual driver who actually drives from a plurality of different drivers. The normal state of the identified actual driver is called up from the storage medium 130 and used. As a result, even if the actual drivers are different, each driver can be identified, and it is possible to provide advice according to each driver.

Further, the storage medium 130 is provided in at least one of the vehicle 1 and the base station 2. As a result, it is possible to obtain the driver's normal state data from the base station 2 even if the vehicle 1 is driven by a plurality of different drivers, such a rental car. It is thus possible to provide advice according to the driver.

Further, the charging advice controller 150 calculates the state difference as a point. This makes it possible to clearly grasp the state difference.

Further, the charging advice controller 150 sets the advice according to the driving experience of the driver. This makes it possible to provide advice that matches the driving experience of the driver.

Further, the charging advice controller 150 learns and updates the stored normal state data according to the change in the current state measured for each driving. This makes it possible to improve the reliability of the data in the normal state of the driver.

### Other Embodiments

The disclosure in this specification and drawings etc. is not limited to the exemplified embodiment. The disclosure includes exemplary embodiments and modifications by those skilled in the art based on them. For example, the disclosure is not limited to the part and/or element combinations shown in the embodiments. The disclosure can be carried out in various combinations. The disclosure can have additional portions that can be added to the embodiment. The disclosure includes those in which the parts and/or elements of the embodiment are omitted. The disclosure includes the reallocation or combination of parts and/or elements between one embodiment and another. The disclosed technical scope is not limited to the description of the embodiment. It should be understood that some disclosed technical ranges are indicated by description of claims, and includes every modification within the equivalent meaning and the scope of description of claims.

The controller (i.e., the charging advice controller 150, the vehicle ECU 144) and method thereof described in the present disclosure in the above embodiments may be implemented by one or more than one special-purpose computer.

Such a special-purpose computer may be created

(i) by configuring (a) a memory and a processor programmed to execute one or more particular functions embodied in computer programs, or

(ii) by configuring (b) a processor provided by one or more special-purpose hardware logic circuits, or

(iii) by configuring a combination of (a) a memory and a processor programmed to execute one or more particular functions embodied in computer programs and (b) a processor provided by one or more special-purpose hardware logic circuits.

Further, the computer program may be stored in a computer-readable non-transitory tangible storage medium as instructions executed by a computer.

Here, the process of the flowchart or the flowchart described in the present embodiment includes a plurality of sections (or steps), and each section is expressed as, for example, S110. Further, each section can be divided into several subsections, while several sections can be combined into one section. Furthermore, each section thus configured may be referred to as a device, module, or means.

For reference to further explain features of the present disclosure, the description is added as follows.

There is known a navigation system for battery electric vehicles. In such a navigation system, a shortest path search unit uses a departure point, destination, current battery level, and battery capacity, and if necessary, the availability information on the charging station or traffic information. To prevent the battery from running out when searching for a route to move from the departure point to the destination, the short path search unit searches for the route that has the shortest travel time, including the charging time, among the routes that pass through n or more charging stations.

Further, at the checkpoint in the middle of the route, the display terminal displays the comparison between (i) the estimated battery level calculated at the time of route search and (ii) the actual battery level when the checkpoint is actually passed. As a result, the user can know whether or not the vehicle is running smoothly.

In the above, the user needs to perform a route search for the navigation system to obtain the information on charging (charging station position information). That is, if not searching for a route, the charging information cannot be obtained. In addition, the user does not need the charging information, especially when he/she is accustomed to driving. By contrast, when the information is clear, the driver feels annoyed. The user needs the charging information in a scene that is out of the normal state of the user during driving. The user needs charging information according to the situation.

It is thus desired for the present disclosure to provide a navigation system for battery electric vehicles that can provide advice commensurate with the degree to which the user's state during driving deviates from the normal state.

An aspect of the present disclosure described herein is set forth in the following clauses.

According to an aspect of the present disclosure, a navigation system for a battery electric vehicle is configured to provide advice to a driver of the battery electric vehicle regarding charging a battery mounted in the battery electric vehicle. The navigation system includes an input device, a storage medium, a measurement device, and a controller. The input device is configured to receive an input of a normal state during driving in advance by the driver. The normal state during driving is recognized by the driver. The storage medium is configured to store the normal state received by the input device. The measurement device is configured to measure a current state during driving. The controller is configured to calculate a difference between the normal state stored and the current state measured, and set the advice according to the difference to provide the driver.

According to this, advice is provided according to the difference (state difference) between the normal state of the driver at the time of driving and the current state. As the state difference is larger, the situation for the driver is more unexpected. The above configuration enables the driver to obtain advice suitable for the varying situation, and drive safely and securely. If the state difference is relatively small, the situation is clear to the driver, and the provision of advice is suppressed. Thus, the driver may not feel annoyed by the advice provided each time.

What is claimed is:

1. A navigation system for a battery electric vehicle a driving source of which is an electric motor driven by a battery, the navigation system providing advice to a driver regarding charging the battery, the navigation system comprising:
an input device configured to receive an input of a normal state during driving in advance by the driver, the normal state during driving being recognized by the driver;
a storage medium configured to store the normal state received by the input device;
a measurement device configured to measure a current state during driving; and
a controller configured to calculate a difference between the normal state stored and the current state measured, and set the advice according to the difference to provide the driver.

2. The navigation system according to claim 1, wherein:
the normal state is a set value set by the driver with respect to an evaluation item; and
the current state is a measured value measured by the measurement device with respect to the evaluation item.

3. The navigation system according to claim 1, wherein:
the advice is set to be (i) the advice for ensuring safety to the driver, (ii) the advice for giving reassurance to the driver, and (iii) the advice for enjoying merits to the driver, in descending order of the difference.

4. The navigation system according to claim 1, wherein:
the controller is configured to notify the driver of a possible event in response to the driver not following the advice.

5. The navigation system according to claim 1, wherein:
the driver is one of a plurality of drivers; and
the normal state is stored in advance in the storage medium for each of the plurality of drivers.

6. The navigation system according to claim 5, wherein:
the controller includes an identification unit configured to identify an actual driver who actually drives the battery electric vehicle from the plurality of drivers; and
the controller is configured to retrieve the normal state of the identified actual driver from the storage medium.

7. The navigation system according to claim 1, wherein:
the storage medium is provided in (i) the battery electric vehicle, or (ii) a base station that wirelessly communicates with the battery electric vehicle, or (iii) each of the battery electric vehicle and the base station.

8. The navigation system according to claim 1, wherein:
the controller is configured to calculate the difference by converting the difference into a point.

9. The navigation system according to claim 1, wherein:
the controller is configured to set the advice according to a driving experience of the driver.

10. The navigation system according to claim 1, wherein:
the controller is configured to learn and update the normal state stored, in response to a change in the current state measured for each of a plurality of driving.

11. A navigation system for providing advice to a driver of a battery electric vehicle regarding charging a battery in the battery electric vehicle, the navigation system comprising:
a storage medium configured to store map data containing road data and facility data including position data of charging stations;
an electric wave signal receiver configured to receive electric wave signals from navigation positioning satellites to obtain a current position of the battery electric vehicle based on the electric wave signals;
an input device configured to receive an input of a destination from the driver; and
a controller communicably coupled to the storage medium, the electric wave signal receiver, and the input device, the controller being configured to guide the battery electric vehicle to the destination based on the map data and the current position of the battery electric vehicle,
wherein:
the input device is configured to further receive, in advance, an input of a plurality of normal states during driving recognized by the driver, the plurality of normal states during driving being respectively corresponding to a plurality of evaluation items;
the storage medium is configured to further store the plurality of normal states during driving received from the input device via the controller; and
the controller is further communicably coupled to in-vehicle devices in the battery electric vehicle, the controller being further configured to
obtain (i) a plurality of current states during driving respectively corresponding to the plurality of evaluation items via the in-vehicle devices, and (ii) the plurality of normal states during driving from the storage medium,
calculate a plurality of differences respectively corresponding to the plurality of evaluation items, a one difference of the plurality of differences being between the normal state during driving and the current state during driving with respect to a corresponding one evaluation item of the plurality of evaluation items, and
set the advice regarding charging the battery based on the plurality of differences to provide the set advice to the driver, wherein the plurality of evaluation items includes at least a first evaluation item being a remaining battery level of the battery.

12. The navigation system according to claim 11, further comprising:
a transceiver mounted in the battery electric vehicle and communicably coupled to the controller to enable the controller to wirelessly communicate with a base station,
wherein:
the storage medium is provided in (i) the battery electric vehicle, or (ii) the base station, or (iii) each of the battery electric vehicle and the base station.
